(19) United States
(12) Patent Application Publication
(10) Pub. No.: US 2010/0242720 A1
(43) Pub. Date: Sep. 30, 2010

(54) Bimetallic Crosshead

(75) Inventors: Mark D. Matzner, Burleson, TX (US); Vladimir Kugelev, Arlington, TX (US)

Correspondence Address: BRACEWELL & GIULIANI LLP, P.O. BOX 61389, HOUSTON, TX, 77208-1389, US

(73) Assignee: Weir SPM, Inc., Fort Worth, TX (US)

(21) Appl. No.: 12/748,127

(22) Filed: Mar. 26, 2010

Related U.S. Application Data
(60) Provisional application No. 61/164,221, filed on Mar. 27, 2009.

(51) Int. Cl. F01B 9/00; F04B 53/14; F16C 5/00; E21B 43/00

(52) U.S. Cl. 92/139; 384/11; 166/105

(57) ABSTRACT

A reciprocating pump assembly having a crankshaft rotatable by an attached motor and coupled by a connecting rod to a crosshead member. On a side opposite the connection to the connecting rod, the crosshead member connects to a plunger. The plunger is coaxially disposed in a cylinder provided in a cylinder block. Rotating the crankshaft reciprocates the crosshead member and attached plunger. In an embodiment the crosshead member includes an outer shell and a core portion within the shell formed from a material different from the shell material.

### CROSS REFERENCE TO RELATED APPLICATIONS

This application claims priority to and the benefit of U.S. Provisional Application Ser. No. 61/164,221, filed Mar. 27^{th}, 2009, the full disclosure of which is hereby incorporated by reference herein.

### FIELD OF THE INVENTION

The present invention relates in general to reciprocating pumps and, in particular, to an improved crosshead assembly.

### DESCRIPTION OF RELATED ART

Reciprocating pumps are employed for use in various oil field service operations. Sometimes referred to as service pumps, oil field reciprocating pumps can pressurize fluids used downhole within a subterranean wellbore for service operations such as, cementing, acidizing, or fracing a well. These service pumps may typically operate for relatively short periods of time, but on a frequent basis such as several times a week. Often they are mounted to a truck or a skid for transport to various well sites.

### SUMMARY OF THE INVENTION

Disclosed herein is a reciprocating pump assembly having a connecting rod, a rotatable crankshaft having an axis and coupled to the connecting rod and rotatable with respect to the connecting rod, a crosshead comprising a core and a liner over the core formed from a material different from the core, the crosshead pivotingly coupled to the connecting rod on an end opposite where the connecting rod couples with the crankshaft, a cylinder block, a cylinder in the cylinder block, and a plunger disposed within the cylinder and mechanically engaged with the crosshead on a side opposite the connecting rod, so that when the crankshaft rotates, the plunger reciprocates within the cylinder. The core can be made from a lightweight material such as aluminum, composites, and combinations thereof. The liner can include, in whole or in part, carbon steel, stainless steel, tungsten, tungsten alloys, nickel alloys, and combinations thereof. A plunger pony rod can be included that is connected to the crosshead with bolts extending through opposing sides of the crosshead. Alternatively, also included can be an end piece on the connecting rod being secured to the connecting rods by bolts. A crosshead disk may be mounted coaxial to the core and on a side opposite the connecting rod. The core can optionally have interstices therein with the liner being substantially solid.

In alternative, a crosshead assembly for use in a reciprocating pump may include an elongated crosshead guide, a bore formed in the crosshead guide in the elongate direction, and a crosshead member reciprocatingly disposed within the bore. In this example the crosshead member can be made up of a core and a cylindrical liner over at least a portion of the core and made from a material different from the core, the liner slidingly engaging the bore of the crosshead guide. The core can have a lightweight material such as aluminum, composites, and combinations thereof. The liner can have carbon steel, stainless steel, tungsten, tungsten alloys, nickel alloys, and combinations thereof. Alternatively, a connecting rod adapted to be attached to the crosshead assembly can be coupled to a side of the crosshead member by a separate end piece attached by bolts, the end piece having a hole for receiving a wrist pin. This example may include a disk coaxially coupled with the core on a side opposite the connecting rod, and wherein a plunger pony rod adapted to be attached to the crosshead assembly can be attached to a side of the disk opposite the core with bolts that terminate within the disk. The core can include interstices therein and the liner can be substantially solid. In an end of the core can be a semi-cylindrical cavity formed for pivoting attachment of the connecting rod; also stays can be included that are affixed to the core, the stays having a portion extending over the cavity, and a hemi-spherical journal in the cavity having ends in contact with the stays. A wrist pin may be included that is insertable through bores formed in the liner and core, where the bores are registerable with a hole in an end of the connecting rod for coupling the connecting rod to the crosshead member. The liner can be a generally tubular member.

A wellbore service fluid reciprocating pump system is also described herein that can have a drive gear, a crankshaft having an axis and engaged with the drive gear, a connecting rod having an end coupled to the crankshaft and a distal end attached by bolts to a separate end piece that is pivotingly coupled to a core portion of a crosshead, a liner over at least a portion of the core portion and formed from a material different from the core portion, a bore formed through the liner, core, and end piece that is oriented transverse to the connecting rod. The system may yet further include a wrist pin disposed in the bore, an annular crosshead guide circumscribing the crosshead and defining a reciprocating path for the crosshead, and a plunger coupled to the crosshead and disposed within a cylinder and attached by bolts that extend between opposite sides of the crosshead. The core for this example can be made from one or more of the following materials: aluminum, composites, and combinations thereof. The liner can be made from one or more of carbon steel, stainless steel, tungsten, tungsten alloys, nickel alloys, and combinations thereof. Yet further, a disk may be included that is coaxially mounted on an end of the crosshead and a plunger pony rod attached on one end to the disk by bolts having a terminal end within the disk, the plunger pony rod attached on another end to the plunger.

### BRIEF DESCRIPTION OF THE DRAWINGS

FIG. 1 is a side perspective view of a reciprocating pump in accordance with the present disclosure.

FIG. 2 is a side partial sectional view of the pump of FIG. 1.

FIG. 3 is an end view of a crosshead and plunger pony rod.

FIGS. 4 and 5 are sectional views of the assembly of FIG. 3 and FIG. 4.

FIG. 6 is a view of the crosshead and plunger pony rod of FIG. 3 from an opposing end.

FIG. 7 is a sectional view of the crosshead of FIG. 6.

FIG. 8 is an overhead view of the crosshead of FIG. 7.

FIG. 9 is a different sectional view of the crosshead of FIG. 7.

FIG. 10 is a schematic of alternative material of the crosshead of FIG. 9.

### DETAILED DESCRIPTION OF THE INVENTION

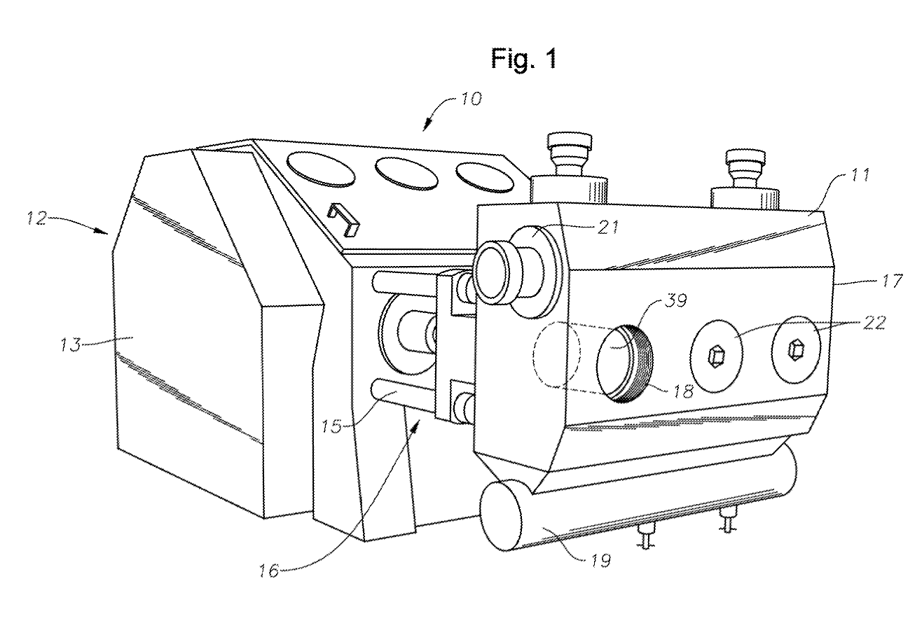

A reciprocating pump assembly 10 is illustrated in FIG. 1 in a side perspective view. The assembly 10 includes a power section 12 coupled to a fluid cylinder portion 11. The pump section 12 is covered by a crankshaft housing 13 that shields components within the pump section 12. A plunger or plunger rod 16 assembly extends between the crankshaft housing 13 and the cylinder section 11. Stay rods 15 adjacent the plunger rod 16 anchor the cylinder section 11 to the pump section 12. The cylinder section 11 includes a cylinder block 17 having cylinder chambers 39 formed therein (shown in dashed outline). Each cylinder chamber 39 is shown herein in alternating fluid communication with a fluid inlet 19 and a fluid outlet 21. Each cylinder chamber 39 end opposite the crankshaft housing 13 is capped with a suction cover plate 22. Openings 18 are formed in the cylinder block 17, each configured to receive a cover plate 22. The pump assembly 10 can easily be mounted to a trailer that can be towed between operational sites, or to a skid such as for offshore operations.

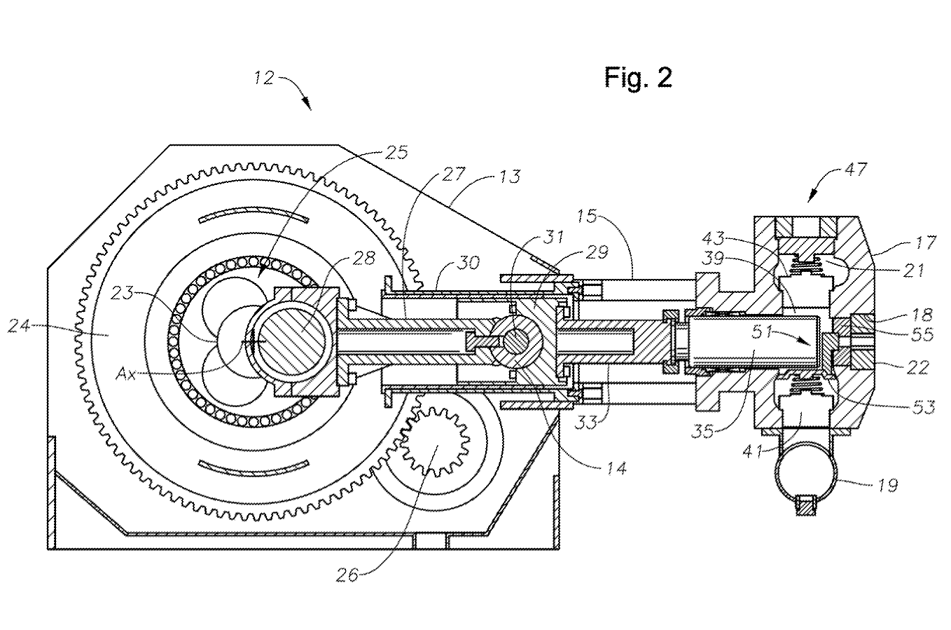

FIG. 2 depicts a side sectional view of the pump assembly 10 of FIG. 1. Crankshaft housing 13 houses a crankshaft 25, which is typically mechanically connected to a motor (not shown). The motor rotates crankshaft 25 in order to reciprocatingly drive a plunger 35 within a corresponding cylinder of the block 17. The crankshaft 25 includes a main shaft 23 that connects to and is rotated by a motor (not shown). In one embodiment, a flywheel gear 24 is illustrated mechanically connecting to the crankshaft 25. Teeth on the flywheel gear 24 mesh with teeth on a drive gear 26, and the drive gear 26 is attached to the motor. A crank pin 28 attaches to the main shaft 23, shown offset from and substantially parallel to the axis Aₓ of the crankshaft 25. An elongated connecting rod 27 is depicted having an integral end with a hole therethrough that receives the crank pin 28A bearing surface therebetween enables the crank pin 28 to rotate with respect to the connecting rod 27. In the embodiment of FIG. 2, the crank pin 28 is offset from the axis Aₓ of the crankshaft 25, so when the crankshaft 25 rotates, the crank pin 28 orbits the axis Aₓ of the crankshaft 25. The rotatable connection between the end of the connecting rod 27 and crank pin 28 causes the connecting rod 27 to reciprocate.

A cross head wrist pin 31 attaches the connecting rod 27 to a cross head 29 on the end of the connecting rod 27 opposite where it attaches to the crank pin 28. A cylindrical end piece 14 secured to connecting rod 27 receives wrist pin 31. As shown in FIG. 2, the connecting rod 27 is substantially horizontally oriented. However, with crankshaft 25 rotation the crank pin 28 orbits the axis Aₓ of the crankshaft 25 thereby raising/lowering the end of the connecting rod 27 attached to the crank pin 28. Alternatingly raising and lowering an end of the connecting rod 27 angles the connecting rod 27 oblique to horizontal. The cross head wrist pin 31 allows the connecting rod 27 to pivot with respect to the crosshead 29. The crosshead 29 of FIG. 2 is a generally disklike member coaxially disposed within a tubular crosshead housing 30. Optionally referred to as a crosshead guide, the crosshead housing 30 is depicted as generally horizontally oriented, having an inner circumference adapted to receive and guide the crosshead 29 along a reciprocating path. Thus as the crank pin 28 orbits with crankshaft 25 rotation, the attached connecting rod 27 pivots and moves laterally back and forth within the crankshaft housing 13 to reciprocate the crosshead 29 within the crosshead housing 30. A plunger pony rod 33 is illustrated connected between the crosshead 29 and the plunger 35, thus when the crosshead 29 is reciprocated by the rotation of the crankshaft 25, the plunger 35 is also reciprocated within the cylinder chamber 39.

An example of an inlet valve 41 is depicted within the cylinder block 17 and controls fluid from the fluid inlet 19 into the cylinder chamber 39. The inlet valve 41 can open as the plunger 35 reciprocates out of the chamber 39 to introduce fluid into the chamber 39, and as the plunger 35 reciprocates back into the chamber 39, the inlet valve 41 closes to isolate the chamber 39 from the fluid inlet 19. As plunger 35 moves longitudinally away from cylinder chamber 39, the pressure of the fluid inside chamber 39 decreases, creating a differential pressure across inlet valve 41, which actuates valve 41 and allows the fluid to enter cylinder chamber 39 from fluid inlet 19. The fluid being pumped enters cylinder chamber 39 as plunger 35 continues to move longitudinally away from cylinder block 17 until the pressure difference between the fluid inside chamber 39 and the fluid in fluid inlet 19 is small enough for inlet valve 41 to actuate to its closed position.

Fluid in the chamber 39 pressurized by the inwardly reciprocating plunger 35 is directed to a fluid outlet 21 shown formed within the cylinder block 17 and adjacent the cylinder chamber 39. An outlet valve 43 is also shown in the cylinder block 17 set between the fluid outlet 21 and a cylinder block discharge 47. The outlet valve 43 controls fluid from the fluid outlet 21 to the cylinder block discharge 47. As plunger 35 begins to move longitudinally towards cylinder block 17, the pressure on the fluid inside of cylinder chamber 39 begins to increase, and continues to increase until the differential pressure across outlet valve 43 exceeds a set point. When the set point is exceeded, the outlet valve 43 opens to allow the fluid to exit cylinder block 17 through fluid outlet 21. In one embodiment, fluid is only pumped across one side of plunger 35, therefore pump assembly 10 is a single-acting reciprocating pump. Valves 41 and 43 can be spring-loaded valves actuated by a predetermined differential pressure.

A suction valve stop assembly 51 is illustrated in the cylinder block 17 adjacent the suction cover plate 22. The suction valve stop assembly 51 comprises two primary components: a suction valve stop 53 and suction cover 55. The suction cover 55, as shown, is generally cylindrical in shape and designed to be mounted sealingly in opening 18 in the cylinder block 17.

Additional crank pins 28 may optionally be provided that are shown illustrated offset from the crankshaft axis Aₓ and at different locations around the circumference of the crankshaft 25. This alternates when fluid is pumped from each cylinder chamber 39 within the cylinder block 17. As is readily appreciable by those skilled in the art, alternating the cycles of pumping fluid from each of cylinder chambers 39 helps minimize the primary, secondary, and tertiary (et al.) forces associated with pump assembly 10.

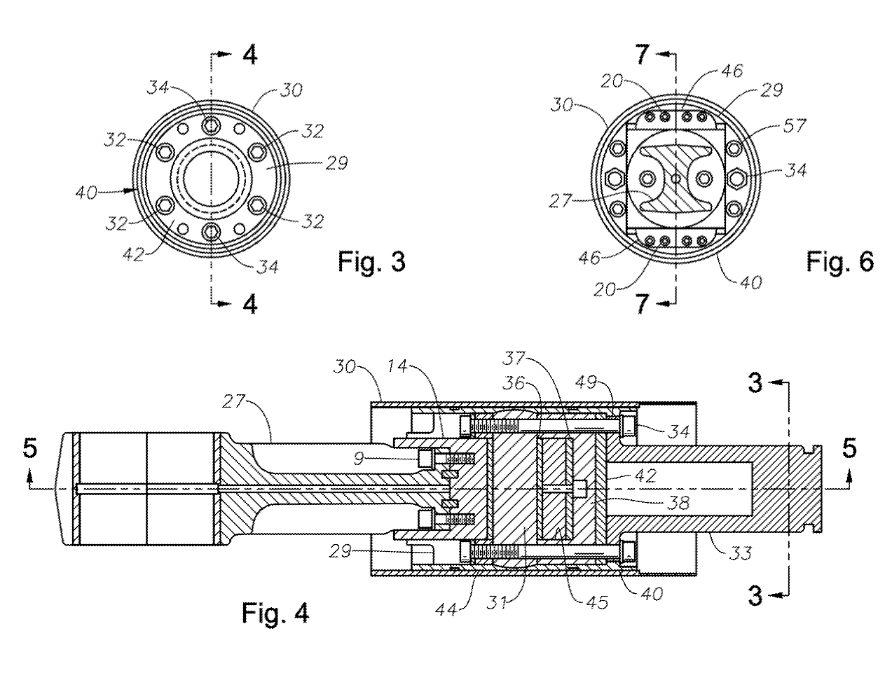

Referring now to FIG. 3, an end view of the crosshead 29 is provided illustrated from the side of the plunger pony rod 33. The crosshead 29 of FIG. 3 is shown having annular liner 40 along its outer periphery and circumscribed by the crosshead guide 30. Bolts 34 extend through and retain the components of the cross head 29, and bolts 32 anchor the plunger pony rod 33 to a disk 42 coaxially provided on an aft side of the cross head 29. FIG. 4 is a sectional view taken along lines 4-4 of FIG. 3; as shown the crosshead 29 includes the disk 42 and an insert 38 (also referred to herein as a core). The insert 38 coaxially abuts against the disk 42 on the side opposite the plunger pony rod 33. The insert 38 and disk 42, as shown, both have a disklike shape similar to the crosshead 29. On its side opposite the disk 42, the insert 38 includes a semi-cylindrical cavity 45 formed to receive the end piece 14 of connecting rod 27, thereby forming a skirt portion on the outer periphery of the insert 38 on the end shown facing the connecting rod 27. End piece 14 is secured to connecting rod 27 by bolts 9. A bore 44 is formed through the skirt portion of the insert 38 and liner 40 in a direction perpendicular to the crosshead housing 30. The bore 44 registers with the cavity 45 so that the connecting rod 27 can connect with the crosshead 29 by inserting the wrist pin 31 within the bore 44. Optionally, to reduce wear on the moving parts, a journal 36 is provided in the space between the wrist pin 31 and connecting rod 27, and a bushing 37 is shown between the connecting rod 27 and insert 38. Bores 49 are shown extending through an external flange on the end of the plunger pony rod 33, the disk 42, the insert 38, and the wrist pin 31. The bolts 34 (FIG. 3) extend completely through the bores 49 to couple the plunger pony rod 33, the disk 42, the insert, and the wrist pin 31.

FIG. 5 is a sectional view of the assembly taken along lines 5-5 of FIG. 4, except connecting rod 27 is shown in a side view rather than sectional view. This view provides an example of the semi-circular cross section of the cavity 45, which allows the connecting rod 27 to pivot within the cavity 45. Also shown are stays 46 affixed by bolts 20 to a side of the insert 38 facing the connecting rod 27 and adjacent where the cavity 45 is formed in the insert 38. At least a portion of the stays 46 extends over cavity 45 and provides a backstop for the opposing ends of the semi-cylindrical bushing 37, thereby retaining the bushing 37 in the cavity 45. A channel 58 is shown in the insert 38 extending between an outer periphery of the insert 38 and behind the journal 36. Lubricant (not shown) can be delivered to the journal 36 through the channel 58. Shown in FIG. 6 is a forward view of the crosshead 29 taken across lines 6-6 of FIG. 5. This embodiment illustrates a pair of stays 46 provided on opposing sides of the insert 38 and each mounted thereon with four bolts 20. The stays 46 are shown as generally elongate planar members, each proximate an inner surface of the liner 40. Bolts 57 extend through the insert 38 and into the disk 42, to attach the insert 38 and disk 42.

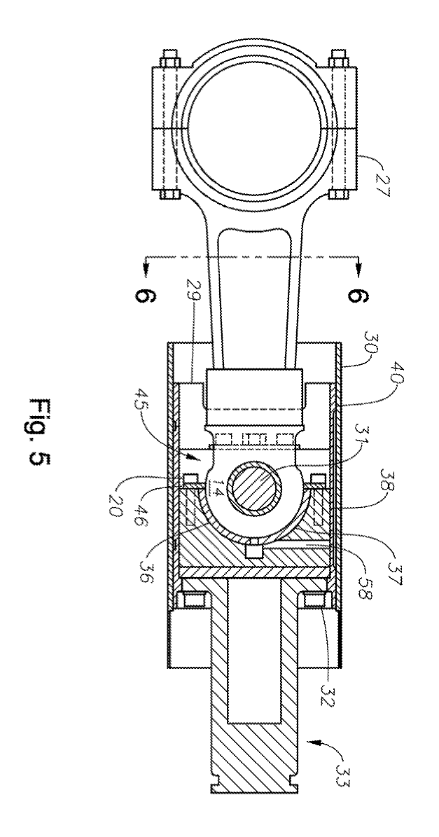

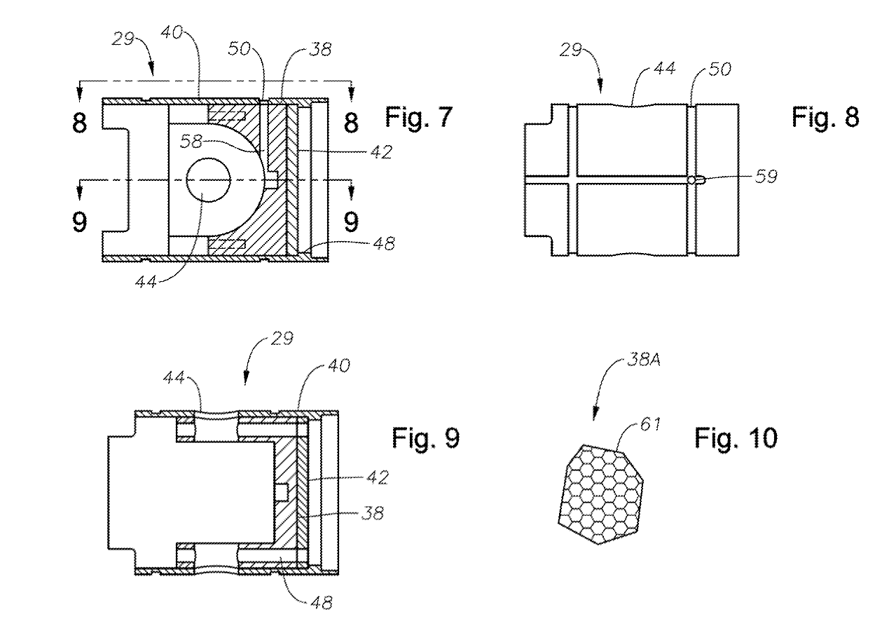

FIG. 7 portrays a sectional view of the crosshead 29 of FIG. 6 and taken along line 7-7 of FIG. 6. This embodiment includes a lip 48 illustrated formed along the inner surface of the liner 40, providing a backstop against which the disk 42 is set. FIG. 8, which is an overhead view of the liner 40 taken along lines 8-8 of FIG. 7, illustrates grooves 50 formed on the outer surface of the liner 40. The grooves 50, are in communication with the channel 58 via a port 59, and provide a path for lubricant to flow over the surface of the liner 40 and reduce friction between the liner 40 and crosshead guide 30. Also shown is how the liner 40 contours inward adjacent the transversely disposed bores 44. A sectional view of the crosshead 29 is shown in FIG. 9 taken along lines 9-9 of FIG. 7. Illustrated are the bores 44 extending through opposing sides of the insert 38 and walls of the liner 40. Also shown are the bores 49 provided to receive the bolts 34 (FIG. 3), depicted longitudinally passing through the disk 42 and insert 38 and transversely intersecting the bores 44.

Unlike traditional crossheads that comprise a single material, which is typically steel or cast iron; the crosshead 29 described herein can include components made from different materials to reduce weight without affecting wear. In one example of use, the insert 38 is formed from a lower density material than either the liner 40 or the disk 42. Examples of materials that can be used in forming the insert 38 include aluminum, copper, brass, tin, composites, ceramics, and combinations thereof. Examples of materials that can be used to create the liner 40 and/or disk 42 include all types of steel, i.e. carbon and stainless, tungsten alloys, nickel, nickel alloys, and combinations thereof. In one example, the material used for the insert 42 has a yield strength that exceeds the yield strength of the material used in forming the insert 38. Strengthening the disk 42 over that of the insert 38, can protect the insert 38 from the applied force from the plunger pony rod 33. Yet further optionally, as illustrated in FIG. 10, the portions of the crosshead 29 can differ in construction. For example, the insert 38 can have interstices 61 or voids therein, such as a honeycomb structure, whereas the liner 40 or disk 42 may be substantially solid. In this example the insert 38 and liner 40 can be formed from the same or different material. Alternatively, the liner 40 or disk 42 can have interstices therein and the insert 38 be substantially solid.

Crosshead weight reduction is an advantage realized by utilizing a lower density material. Although lower density materials may also have lower yield and tensile strengths, the crosshead 29 configuration as described herein subjects the insert 38 only to compression forces and not tensile forces. Thus the pumping capacity is not diminished by the advantage of weight reduction. Advantages of the device described herein include ease of assembly and disassembly and increased lifetime of the pump moving parts due to reducing the inertia forces.

While the invention has been shown in only one of its forms, it should be apparent to those skilled in the art that it is not so limited, but is susceptible to various changes without departing from the scope of the invention.

What is claimed is:

1. A reciprocating pump assembly comprising:
a connecting rod;
a rotatable crankshaft having an axis and coupled to the connecting rod and rotatable with respect to the connecting rod;
a crosshead comprising a core and a liner over the core formed from a material different from the core, the crosshead pivotingly coupled to the connecting rod on an end opposite where the connecting rod couples with the crankshaft;
a cylinder block;
a cylinder in the cylinder block; and
a plunger disposed within the cylinder and mechanically engaged with the crosshead on a side opposite the connecting rod, so that when the crankshaft rotates, the plunger reciprocates within the cylinder.

2. The reciprocating pump assembly of claim 1, wherein the core comprises a material selected from the list consisting of aluminum, composites, and combinations thereof.

3. The reciprocating pump assembly of claim 1, wherein the liner comprises a material selected from the list consisting of carbon steel, stainless steel, tungsten, tungsten alloys, nickel alloys, and combinations thereof.

4. The reciprocating pump assembly of claim 1, further comprising:
a plunger pony rod connected to the crosshead with bolts extending through opposing sides of the crosshead.

5. The reciprocating pump assembly of claim 1, further comprising an end piece on the connecting rod being secured to the connector rods by bolts.

6. The reciprocating pump assembly of claim 1, further comprising a crosshead disk mounted coaxial to the core and on a side opposite the connecting rod.

7. The reciprocating pump assembly of claim 1, wherein the core comprises interstices therein and the liner is substantially solid.

8. A crosshead assembly for use in a reciprocating pump, the crosshead comprising:
an elongated crosshead guide;
a bore formed in the crosshead guide in the elongate direction; and
a crosshead member reciprocatingly disposed within the bore, the crosshead member comprising:
a core, and
a cylindrical liner over at least a portion of the core and made from a material different from the core, the liner slidingly engaging the bore of the crosshead guide.

9. The crosshead assembly of claim 8, wherein the core comprises a material selected from the list consisting of aluminum, composites, and combinations thereof.

10. The crosshead assembly of claim 8, wherein the liner comprises a material selected from the list consisting of carbon steel, stainless steel, tungsten, tungsten alloys, nickel alloys, and combinations thereof.

11. The crosshead assembly of claim 8, wherein a connecting rod adapted to be attached to the crosshead assembly is coupled to a side of the crosshead member by a separate end piece attached by bolts, the end piece having a hole for receiving a wrist pin.

12. The crosshead assembly of claim 11, further comprising a disk coaxially couples with the core on a side opposite the connecting rod, and wherein a plunger adapted to be attached to the crosshead assembly is attached to a side of the disk opposite the core with bolts that terminate within the disk.

13. The crosshead assembly of claim 8, wherein the core comprises interstices therein and the liner is substantially solid.

14. The crosshead assembly of claim 11, further comprising a semi-cylindrical cavity formed in an end of the core for pivoting attachment of the connecting rod, stays affixed to the core and having a portion extending over the cavity, and a hemi-spherical journal in the cavity having ends in contact with the stays.

15. The crosshead assembly of claim 14, further comprising a wrist pin insertable through bores formed in the liner and core that are registerable with a hole in an end of the connecting rod for coupling the connecting rod to the crosshead member.

16. The crosshead assembly of claim 8, wherein the liner is a generally tubular member.

17. A wellbore service fluid reciprocating pump system comprising:
a drive gear;
a crankshaft having an axis and engaged with the drive gear;
a connecting rod having an end coupled to the crankshaft and a distal end attached by bolts to a separate end piece that is pivotingly coupled to a core portion of a crosshead;
a liner over at least a portion of the core portion and formed from a material different from the core portion;
a bore formed through the liner, core, and end piece that is oriented transverse to the connecting rod;
a wrist pin disposed in the bore;
an annular crosshead guide circumscribing the crosshead and defining a reciprocating path for the crosshead; and
a plunger coupled to the crosshead and disposed within a cylinder and attached by bolts that extend between opposite sides of the crosshead.

18. The system of claim 17, wherein the core comprises a material selected from the list consisting of aluminum, composites, and combinations thereof and wherein the liner comprises a material selected from the list consisting of carbon steel, stainless steel, tungsten, tungsten alloys, nickel alloys, and combinations thereof.

19. The system of claim 17, further comprising a disk coaxially mounted on an end of the crosshead and a plunger rod attached on one end to the disk by bolts having a terminal end within the disk, the plunger pony rod attached on another end to the plunger.
